(19) United States
(12) Patent Application Publication
(10) Pub. No.: US 2022/0117841 A1
(43) Pub. Date: Apr. 21, 2022

(54) MASSAGE GUN HOLDER

(71) Applicant: Custom Product Innovations, Inc., Lebanon, IL (US)

(72) Inventor: Dylan Tellam, Saint Louis, MO (US)

(21) Appl. No.: 17/493,875

(22) Filed: Oct. 5, 2021

Related U.S. Application Data
(60) Provisional application No. 63/091,959, filed on Oct. 15, 2020.

(51) Int. Cl. A61H 37/00; A61H 23/00

(52) U.S. Cl. CPC A61H 37/00; A61H 23/006; A61H 2201/0153; A61H 2201/1623; A61H 2201/1609; A61H 2201/1614; A61H 2201/0157

(57) ABSTRACT

A massage gun holder (e.g., to hold a massage gun in a manner that enables a user to effectively self-massage for therapeutic or relaxation purposes with ease) has a tube (shaft) with a first end and a second end, a series of alternating bends and straight segments between the first end and the second end, and a massage gun engager (configured to receive and engage the massage gun) at a second end of the tube. The massage gun engager has an opening to receive a portion of a massage gun.

### CROSS-REFERENCE TO RELATED APPLICATIONS

The present application claims the benefit of priority to U.S. Provisional Patent Application No. 63/091,959, entitled Massage Gun Holder, which was filed on Oct. 15, 2020. The disclosure in the prior application is incorporated by reference herein in its entirety.

### FIELD OF THE INVENTION

This disclosure relates to a massage gun holder and, more specifically, to a massage gun holder that facilitates providing one's own self with a massage using a massage gun.

### BACKGROUND

A massage gun is an electric massage appliance or, more specifically, an electric vibrating massager. One example of a massage gun is the HyperVolt® massage gun, which is available from Hyper Ice, Inc.

### SUMMARY OF THE INVENTION

In one aspect, a massage gun holder has a tube having a first end and a second end, a series of alternating bends and straight segments between the first end and the second end, and a massage gun engager at a second end of the tube with an opening to receive a portion of a massage gun.

In another aspect, a massage gun holder has a tube having a first end and a second end. The tube has an end-to-end length between 42 inches and 54 inches. There is a series of bends between the first end and the second end. The series of bends in the tube add up to between 170 degrees and 210 degrees. A grip is at the first end of the tube. A massage gun engager is at the second end of the tube. The massage gun engager includes a barrel portion coupled to the tube, a collar portion coupled to a distal end of the barrel portion, and a latching mechanism coupled to the collar portion. The barrel portion defines a window sized and configured to enable a user to view and access, by hand, one or more controls or functional features on a bottom surface of a handle portion of a massage gun in the massage gun engager.

In yet another aspect, a massage system includes a massage gun holder and a massage gun engaged to the massage gun holder. The massage gun holder has a tube with a first end and a second end. The tube has an end-to-end length between 42 inches and 54 inches. There is a series of (alternating) straight segments and bends between the first end and the second end. The series of bends in the tube add up to between 170 degrees and 210 degrees. A massage gun engager is at a second end of the tube and has an opening to receive a portion of a massage gun. A barrel portion of the massage gun engager defines a cut-out window sized and configured to enable a user to view and access one or more controls or functional features on (e.g., a bottom surface of a handle portion of) an engaged massage gun. The massage gun engager has a latching mechanism at a distal end of the massage gun engager to grip a handle of the engaged massage gun. The massage gun engaged to the massage gun holder has a handle portion that extends into and is engaged by the massage gun engager of the massage gun holder.

In some implementations, one or more of the following advantages are present. For example, in a typical implementation, the massage gun holder disclosed herein provides a convenient tool for delivering oneself an effective, enjoyable, and/or relaxing massage with a massage gun (that has a vibrating or percussive massage head), particularly in areas of the body (e.g., back, neck, shoulders, etc.) that traditionally have been difficult, if not impossible, to effectively massage on one's own body.

Other features and advantages will be apparent from the description and drawings, and from the claims.

### BRIEF DESCRIPTION OF THE DRAWINGS

FIG. 1 is a schematic perspective view of an implementation of a massage gun holder and a massage gun coupled to the massage gun holder.

FIG. 2 is a partial schematic perspective view of an implementation of a massage gun holder next to a massage gun.

FIG. 3 is a partial schematic perspective view of an implementation of a tube and barrel portion of massage gun holder.

FIG. 4 is a schematic perspective view of a user using an implementation of a massage gun holder and a massage gun coupled to the massage gun holder to massage the user's own back.

FIG. 5 is a perspective view of an exemplary barrel portion of a massage gun holder and a bottom surface of a handle portion of an engaged massage gun visible through a window in the barrel portion.

FIG. 6A is a schematic front view of an exemplary barrel portion of a massage gun engager.

FIG. 6B is a schematic side view of the barrel portion from FIG. 6A. FIG. 6C is a schematic end view of the barrel portion from FIG. 6A.

FIG. 7A is a schematic top view of an exemplary washer that may form part of the barrel portion of a massage gun engager.

FIG. 7B is a schematic side view of the washer of FIG. 7A.

FIG. 8A is a schematic front view of an exemplary implementation of a shaft and barrel portion of a massage gun holder.

FIG. 8B is a schematic top view of an exemplary implementation of the shaft and barrel of the massage gun holder of FIG. 8A.

FIG. 8C is a schematic side view of an implementation of the shaft and barrel of the massage gun holder of FIG. 8A.

FIG. 8D is a schematic perspective view of an implementation of the shaft, barrel, and washer of the massage gun holder of FIG. 8A.

Like reference characters refer to like elements. Indicators of scale in any of the drawings should not be deemed as necessarily limiting.

### DETAILED DESCRIPTION

The figures show an implementation of a massage gun holder 100 and/or parts thereof, as well as a massage gun 102 coupled to the massage gun holder 100. The figures also show a user using the massage gun holder 100 to massage his own back.

A massage gun is an electric massage appliance or, more specifically, an electric vibrating massager. The illustrated massage gun 102 has a housing 104 that defines a handle portion 106 and a barrel portion 108. The handle portion 106 and the barrel portion 108 in the illustrated implementation lie along axes that are angled relative to one another. The angle can vary somewhat. In some implementations, the handle portion 106 of the massage gun 102 is orthogonal (i.e., disposed 90° relative) to the barrel portion 108 of the massage gun 102. However, this angle (between the handle portion 106 and the barrel portion 108 of the massage gun) can vary somewhat (e.g., in various implementations, the angle could be anywhere between 80° and 110°).

A vibrating member 110 extends out from a distal end of the barrel portion 108 of the housing 104. When the massage gun 102 is in use, the vibrating member 110 moves (e.g., vibrates) relative to the housing 104.

In a typical implementation, the vibrating member 110 is sized and shaped to receive a head attachment that can be attached to the vibrating member 110. In some implementations, the vibrating member 110 may be sized and shaped to receive any one of a plurality of interchangeable head attachments. In those implementations, each head attachment may have a different configuration (e.g., a fork shape, a ball shape, a cushion configuration, a flat portion, a bullet shape, etc.) to provide a different type of massage sensation/experience to the massage recipient.

In use, a person might grip the handle portion 106 of the housing 104 and press the vibrating member 110 (or whatever head attachment might be attached to the vibrating member) against a portion of the massage recipient's body. People may use the massage gun 110 to massage themselves or others. Sometimes, people have a hard time delivering an effective massage to themselves, however. This is because it can be difficult, if not impossible, to reach certain areas of their own bodies and apply the necessary or desirable amount of pressure.

Chiropractors and massage therapists, for example, may use massage guns to massage their clients. Although these massage can be effective and helpful, some of the clients may not really need the expertise of a chiropractor or massage therapist and/or may not be able to (or want to) pay the recurring costs associated with visits to the chiropractor or massage therapist. These people may just need a massage from a massage gun to help work out strain-related knots and the like in their backs, for example. Until now, people could not just buy the massage gun and do it themselves because with a massage gun, like the Hypervolt® massage gun, it is not really possible to reach the majority of one's own back (or other areas on the body) where knots commonly build-up.

Moreover, when holding a massage gun, it is not generally feasible to effectively massage some areas on your own body that are reachable. For example, it is usually possible to reach one's own neck and shoulders with a massage gun. However, when doing so, at least some of the muscles being targeted for massage will not be at rest when straining to reach them. As soon as one reaches an arm up to massage his or her own neck, the muscles in that person's arm, neck, shoulders and upper back are activated. When in flexion, muscles are contracting, which make them tighter. When that happens, in some instances, rhythmically beating on those muscles (e.g., with a percussive massage gun) massager can do more harm than good; certainly, any therapeutic or relaxation effect will be reduced by the fact that the muscles are not relaxed when being massaged. When properly massaging an area, the muscles in that area should generally be at rest and as free from strain as possible.

The device disclosed herein (referred to as a massage gun holder) harnesses the massage gun and gives its user the ability to massage his or her own back (and other body parts) in an easy and effective manner. Moreover, the massage gun holder lets people massage themselves without having to substantially activate the muscles being massaged.

The massage gun holder 100 in the illustrated implementation has three main components: a tube 112, a grip 114, and a massage gun engager 116. In a typical implementation, the tube 112 includes a rigid, hollow (or solid) shaft (or pipe) with a series of bends and straight portions between its two ends. The bends, in the illustrated implementation, all bend in the same direction. The grip 114 is at a first end of the tube 112 and the massage gun engager 116 is at a second end of the tube 112, opposite the first end.

More specifically, the tube 112 in the illustrated implementation has a series of straight segments separated from one another by bends. In the illustrated implementation, there are four straight segments 118, 122, 126, and 130, and three bends 120, 124, 128. Starting from a first end of the tube 112, the tube 112 has a first straight segment 118, followed by a first bend 120, followed by a second straight segment 122, followed by a second bend 124, followed by a third straight segment 126, followed by a third bend 128, followed by a fourth straight segment 130.

Starting from the first end of the tube 112, the first straight segment 118 is 14 inches long and the first bend 120 is 60 degrees (defining an angle of 120 degrees between the first straight segment 118 and the second straight segment 122). The second straight segment 122 is also 14 inches long and the second bend 124 is also 60 degrees (defining an angle of 120 degrees between the second straight segment 122 and the third straight segment 126. The third straight segment is 13 inches long and the third bend is 70 degrees (defining an angle of 110 degrees between the third straight segment 126 and the fourth straight segment 130. The fourth straight length is 7 inches long. The length of each straight segment can vary. In various implementations, for example, any one or more (or all) of these lengths can vary as much as +/−10% or more (e.g., +/−15%, +/−20%, +/−25%, etc.) from the aforementioned length dimensions. Likewise, the angular dimension of each bend can vary as well. In various implementations, for example, any one or more of these bends can vary as much as +/−10% or more (e.g., +/−15%, +/−20%, +/−25%, etc.). Moreover, in the illustrated implementation, the overall length of the tube 112 (end-to-end) is approximately 48 inches (e.g., 14 inches+14 inches+13 inches+7 inches). The overall length of the tube can vary. In various implementations, for example, the overall length of the tube can be anywhere between 42 inches and 54 inches.

In the illustrated implementation, every bend and every segment of the tube 112 lies in one common plane. In other words, none of the segments has any portion that bends out of the common plane. This, however, can vary as well. For example, in various implementations, the tube 112 may have one or more bends that result in one or more portions or segments of the tube 112 extending out of the otherwise common plane. In various implementations, for example, one or more portions or segments of the tube 112 may bend out from the otherwise common plane as much as +/−10 degrees or more (e.g., +/−15 degrees, +/−20 degrees, +/−25 degrees, etc.). In the illustrated implementation, the series of bends in the tube 112 adds up to a total of 190 degrees (e.g., 60 degrees+60 degrees+70 degrees). This, of course, can vary as well. For example, in various implementations, the series of bends in the tube 112 may add up to a total of anywhere between 170 degrees and 210 degrees.

The tube 112 in the illustrated implementation has four straight segments 118, 122, 126, 130 separated from one another by three bends 120, 124, 128. This, too, can vary. For example, in some implementations, the tube 112 may include fewer bends and fewer straight segments. Conversely, in some implementations, the tube 112 may include more bends and more straight segments.

In view of the foregoing discussion, it should be clear that the tube 112 can take on any one of a variety of possible physical configurations and that the illustrated implementation is but one of those possible configuration. Ultimately, the tube 112 may be considered effective if it is configured in such a manner that a massage gun can be coupled to a massage gun engager 116 at one of the tube 112 and a user can hold (e.g., a grip 114) at an opposite end of the tube 112 and massage one or more difficult-to-self-massage areas on his or her own body (e.g., his or her own back.

The grip 114 in the illustrated implementation is a covering on a gripping end of the tube 112. Though not essential to functionality, it is a nice feature. The grip 114 in the illustrated implementation, covers a significant portion (e.g., more than 80%) of the first straight segment 118 of the tube 112 from the end of the tube 112. In some implementations, the grip 114 is a textured vinyl material tube with a 1-inch inner diameter and is 11 inches in length. The grip 114 is fit over and slid onto the end of the tube 112. The length of the grip can, of course vary, but will generally be at least about 6 inches. The grip fits over the end of the tube opposite the massage gun engager 116 and provides the user with a comfortable gripping surface.

The massage gun engager 116 is attached to an end of the tube 112 opposite the grip 114. The massage gun engager 116 in the illustrated implementation has a barrel portion 132, a collar portion 134, and a latching mechanism 136.

The barrel portion 132 has a rigid, hollow, generally tubular portion 133 and a washer portion 135 at one end of the generally tubular portion 133. An outer, circumferential edge of the washer portion 135 is attached (e.g., by a weld, or glue, etc.) to the generally tubular portion 133. An inner, circumferential edge of the washer portion 135 is attached (e.g., by a weld, or glue, etc.) to the end of the tube 112.

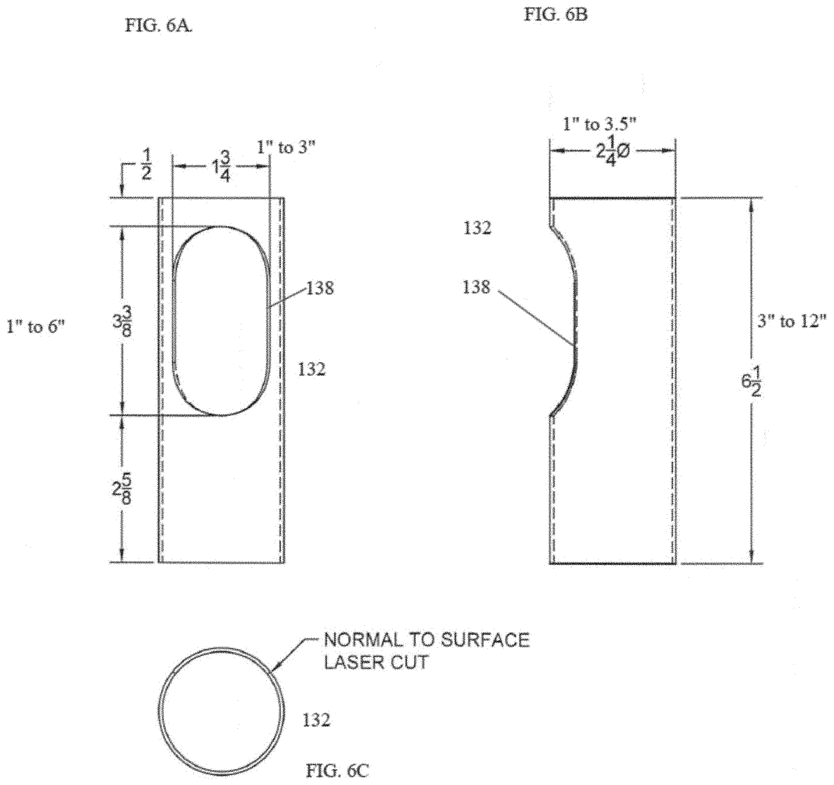

The generally tubular portion 133 of the barrel portion 132 of the massage gun engager 116 is configured to define a window 138 on a side surface of the generally tubular portion 133, and an opening 137 at a distal end of the generally tubular portion 133 (opposite the washer portion 135) and to define. Collectively, the window 138 and the opening 137 are sized and shaped to enable a user to access, by hand, any controls or other features of the massage gun 102 that may be on a bottom surface of the handle portion 106 of the massage gun 102. For example, on some massage guns, there is a power button (see, e.g., 550 in FIG. 5) on the bottom surface of the handle portion 106. As another example, on some massage guns, there is a charging port (see, e.g., 552 in FIG. 5) for an electrical charging cable on the bottom surface of the handle portion 106. In a typical implementation, the window 138 and the opening 137 would be configured to enable a user to access and manipulate the power button and access the charging ports to plug in or remove an electrical charging cable while the massage gun 102 is engaged to the massage gun holder 100.

The size and shape of the window 138 in the curved side surface of the tubular portion 133 of the massage gun engager 116 can vary considerably. Instead of appearing stadium-shaped, the window 138 could be shaped to appear circular, rectangular, square, or virtually any other shape. Additionally, the window 138 can be larger or smaller than shown. In general, as long as the window 138 is large enough to enable a user to access, by hand, any controls and/or features on the bottom of the surface of the handle portion 106 of the massage gun 104, the window 138 will be large enough for its intended purpose.

Likewise, the size and shape of the opening 137 at the distal end of the barrel portion 132 of the massage gun engager 116 can vary as well. In some implementations, the opening 137 is circular with a diameter that matches the size and shape of the cylindrical interior of the tubular portion 133 of the barrel portion 132 of the massage gun engager 116. In other implementations, however, instead of being circular, the opening 137 could be rectangular, square, or virtually any other shape. Additionally, the opening 137 can be smaller than shown. Like the window 138, as long as the opening 137 is large enough to enable a user to access, by hand, any controls and/or features on the bottom of the surface of the handle portion 106 of the massage gun 104, the opening 137 will be large enough for its intended purpose.

The collar portion 134 of the massage gun engager 116 is attached (e.g., by a weld, or glue, etc.) to a distal end of the generally tubular portion 133 of the massage gun engager 116. The collar portion 134 has a rigid, hollow, generally tubular body that defines a circular opening at each end thereof. In a typical implementation, the generally tubular body of the collar portion 134 defines a substantially cylindrical interior space that is sized and shaped to receive the handle portion 106 of the massage gun 102. The substantially cylindrical space inside the generally tubular body of the collar portion 134 is sized and shaped to receive the handle portion 106 of the massage gun 102.

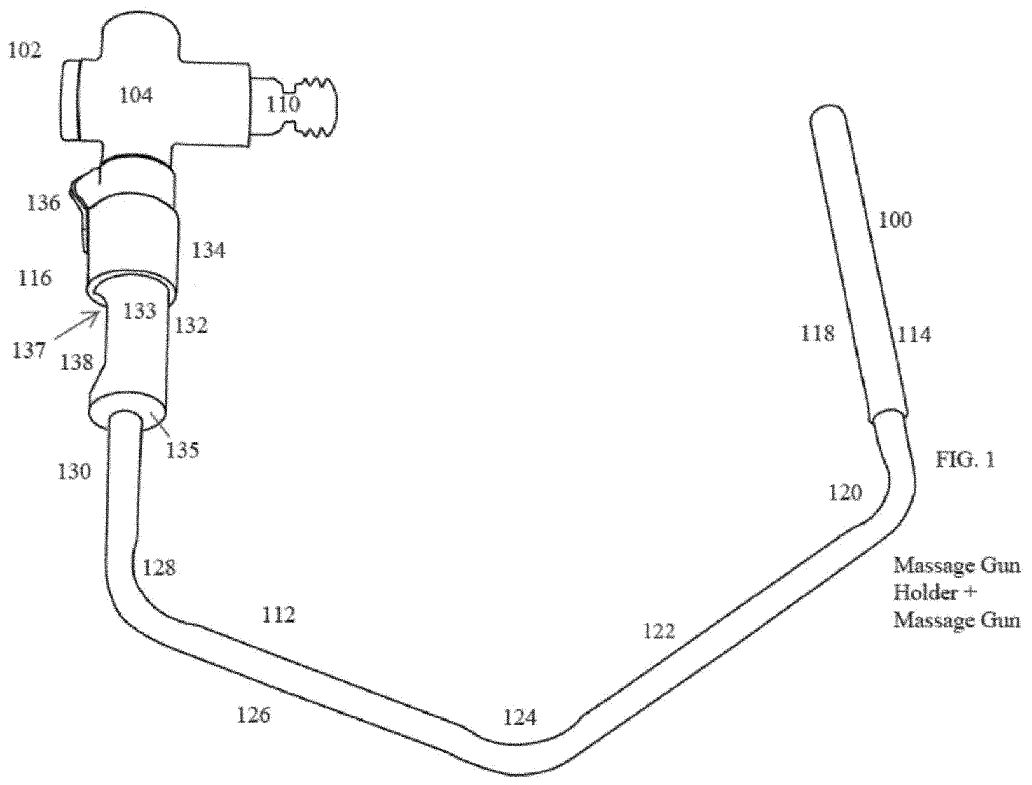

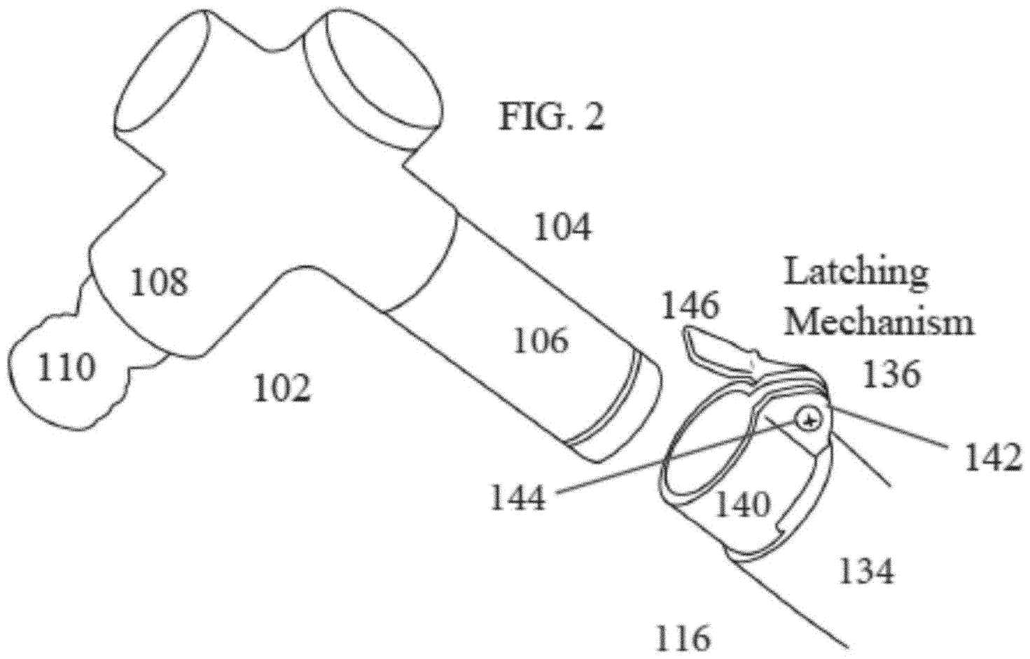

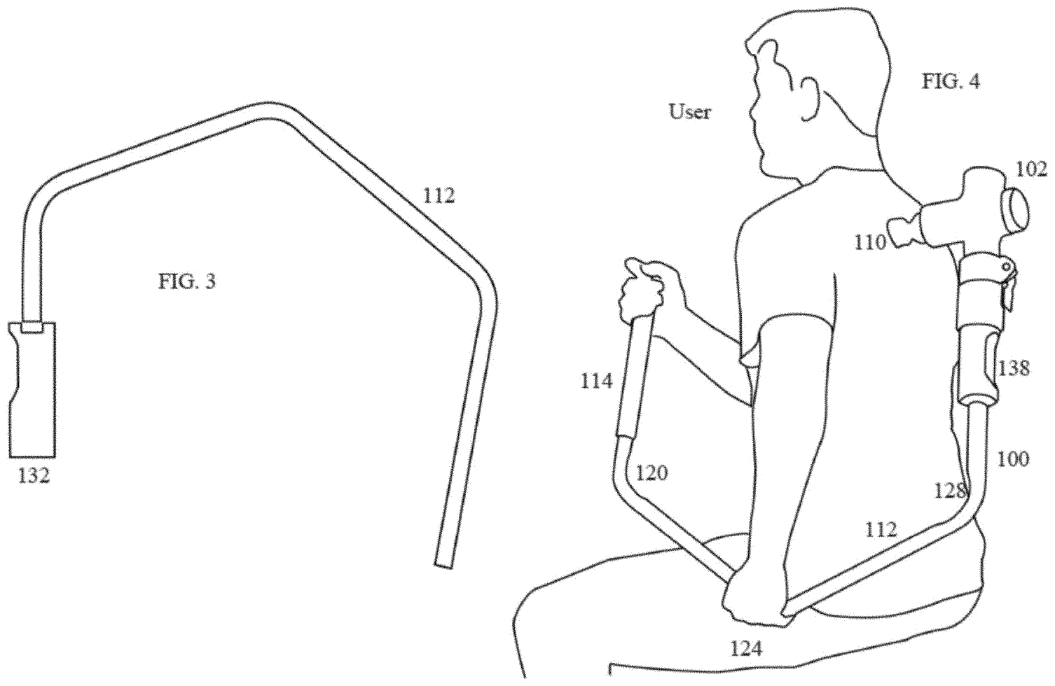

The latching mechanism 136 is attached (e.g., by a weld or glue) to a distal end of the collar portion 134 of the massage gun engager 116. The latching mechanism 136 defines a substantially cylindrical interior space that is sized and shaped to receive the handle portion 106 of the massage gun 102 and to allow the handle portion 106 of the massage gun 102 to extend through the interior space. The latching mechanism 136 is also manipulatable to grip or latch onto the handle portion 106 of the massage gun 102 to hold it in place (e.g., as shown in FIG. 1). The latching mechanism 136, in various implementations, can take on any one of a variety of different forms. In essence, the latching mechanism 136 is a user-manipulable component that secures the massage gun 102 to the massage gun holder 100. In the illustrated implementation, the latching mechanism 136 has an adjustable split collar portion 140 with flanged ends 142 that face (and can be moved closer to or further away from each other). A screw 144 passes through a hole in each of the flanged ends 142 and engages a threaded hole in a lever 146 that is on an opposite side of the flanged ends 142 from the screw head.

In use, the lever 146 of the latching mechanism 136 can be turned in one direction relative to the screw 144 (and about the screw's axis) to pull the screw 144 into deeper engagement with the threaded hole on the lever 146, which moves the flanged ends 142 of the adjustable split collar 140 closer together, which causes the adjustable split collar 140 to grip the housing of the massage gun 102 more tightly. Alternatively, the lever 146 can be turned in an opposite direction relative to the screw 144 (and about the screw's axis) to move the screw 144 out of the threaded hole on the lever 146, which allows the flanged ends 142 of the adjustable split collar 140 to flex outwardly, thereby loosening their grip on the housing of the massage gun 102.

In various implementations, the latching mechanism 136 can may be implemented as a plastic latching coupler as used for telescopic tubes, for example, as disclosed in U.S. Pat. No. 6,908,249, which is hereby incorporated by reference in its entirety.

In a typical implementation, engaging the massage gun 102 to the massage gun holder 100 is a simple and straightforward endeavor. To do so, one would place the latching mechanism 136 in an open (or unlatched) position or ensure that the latching mechanism 136 is in that open position. This ensures that the handle portion 106 of the massage gun 102 will be free to pass through the latching mechanism 136 and engage the massage gun engager 116.

Next, the user slides the handle portion 106 of the massage gun 102 into the opening at a distal end of the massage gun engager 116 through the latching mechanism 136. Typically, the handle portion 106 is slid into the opening a sufficient distance that the bottom portion of the handle portion reaches (and typically snugly mates with) the barrel portion 132 of the massage gun engager 116. The user does this in a manner such that the vibrating member 110 massage gun 102 is generally facing the tip of the grip portion 118 of the massage gun holder 100. Once the handle portion 106 of the massage gun 102 has been slid into the opening at the end of the massage gun engager 116 fully, the user can manipulate the lever 146 on the latching mechanism 136 to tighten the adjustable split collar portion 140 of the latching mechanism 136 thereby gripping the handle portion 106 of the massage gun 102 to hold the massage gun 102 securely in place coupled to the massage gun holder 100.

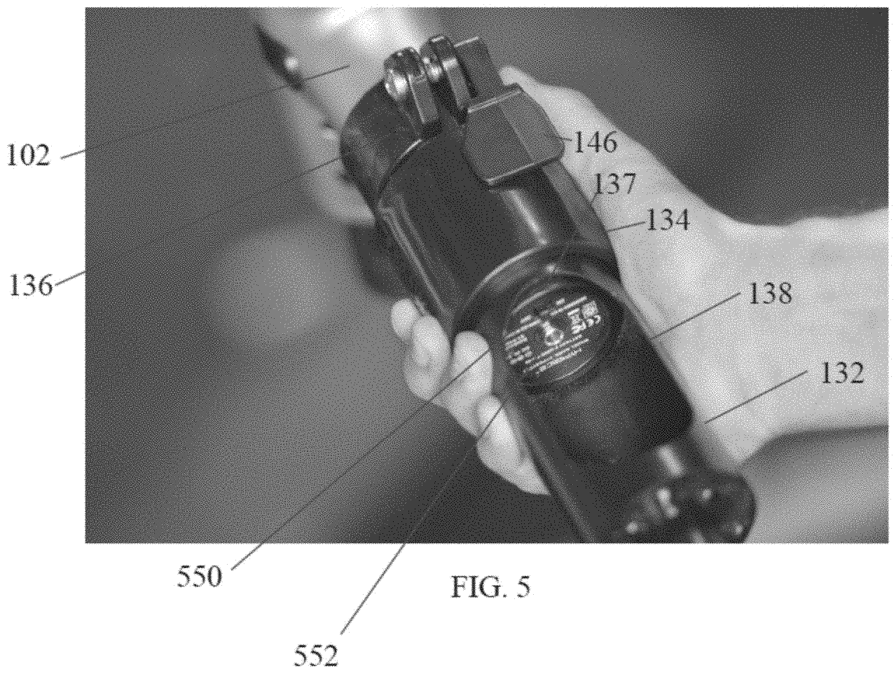

FIG. 4 shows an example of a user using the massage gun holder 100 to hold a massage gun 102 while massaging his own back.

The user, like most people using a massage gun holder 100, has his dominant hand (his right hand in the illustrated example) on the grip 114. The massage gun holder 100 hooks around his body, under his less dominant arm (his left arm in the illustrated example) and around to his back. His less dominant (left) arm is draped over the device and his less dominant (left) hand is gripping the tube 112, at /near the second bend 124 of the tube 112. Typically, a user would grip the tube 112 with his or her less dominant hand somewhere between the first bend 120 and the third bend 128, wherever feels most natural. As shown, the user's less dominant (left) hand is slightly lower than his dominant (right) hand. With the massage gun 102 properly engaged to the massage gun holder 100 and the user holding the massage gun holder 100 in this manner, the vibrating member 110 of the massage gun 102 can very easily be placed against the user's own back and pressure applied to the user's back while maintaining a relative degree of relaxation in the muscles being massaged.

Once in this position, the massage can begin. To target certain areas on his back, the user can change the massage gun's position by using his hand on the massage gun holder as a stationary fulcrum point while using the other hand as a driving force to reposition the vibrating member (e.g., percussion head) across his back. Which arm the user moves may depend on which axis he is trying to move on his back. This method may be used for small incremental changes of position on his back. For larger movement, both hands can be used as a driving force in a large sweeping motion (similar to the feeling of rowing a boat with a single oar) to reposition the massage gun over a greater area.

The hooked design of the massage gun holder 100 makes it possible for the user to keep his arms substantially hanging down to his sides while it is in use. By keeping his arms in these kinds of relatively neutral positions, the muscle activation in his back, shoulders, neck, and traps is limited, which enhances the effectiveness of his self-massage. The hooked design also allows for a large range of motion as there is no part of the user's body that cannot be reached with the massage gun holder 100.

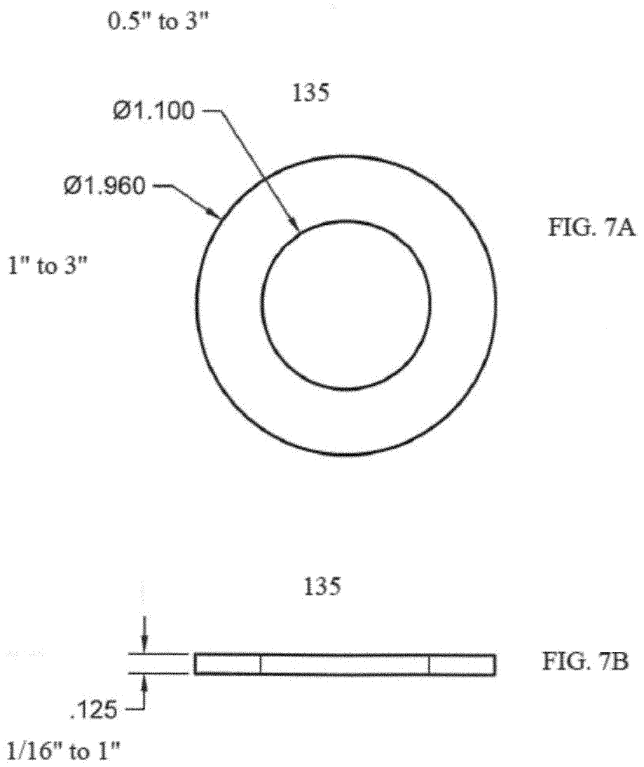

FIGS. 6A to 6C show detailed views of an exemplary barrel portion 132 of the massage gun holder 100, with exemplary dimensional information including dimensional ranges for certain dimensions.

The barrel portion 132 in this example is 2.25 inches wide and 6.5 inches long with a 2 inch inside diameter (0.065 inches wall thickness) because the handle of the Hypervolt® massage gun is exactly two inches wide. The barrel portion 132 is attached (e.g., by a weld, or glue, etc.) onto a smaller diameter tube for weight purposes though the entire tube can be constructed out of a tube of this diameter (e.g., such that the tube and the barrel have the same diameter). The barrel portion 132 has an opening cut out of it that is 3⅜ inches tall and 1¾ inches wide with a radius on the corners for turning the tool on and off and allowing for a charger.

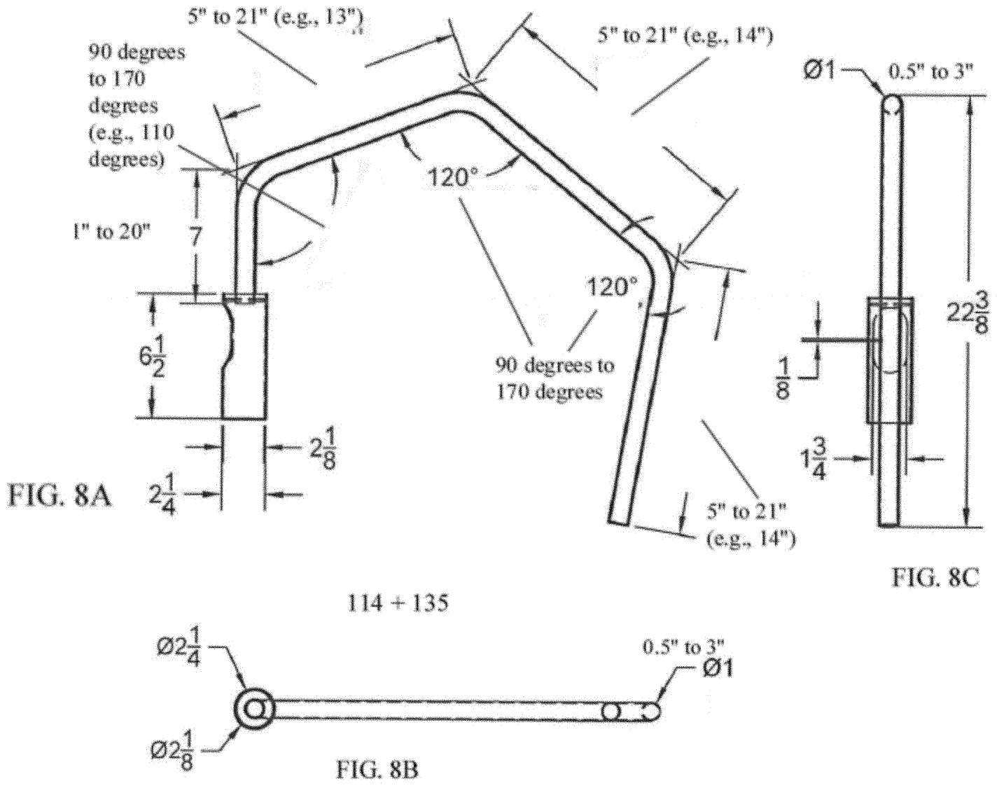

FIGS. 7A and 7B show a washer 135, which would be provided at the bottom of the barrel portion 132, and exemplary dimensions as well as exemplary dimensional ranges of same. The acts as a reducer to connect the barrel portion 132 to a smaller-diameter tube (e.g., 112). If the tube 112 is a 1″ tube, for example, the washer may have an outside diameter of 1.96″ inches to fit within the inner diameter of the barrel portion 132, which may be 2″. The washer 135 may have a 1.1″ inside diameter (hole) to allow the 1″ tube 112 to fit within it. This washer 135 may be, for example, 0.125 inches thick.

Several components (including, for example, the tube 112, portions of the massage gun engager 116) example are made of steel and were welded together to connect them. Though this product can be made out of a number of rigid materials including but not limited to steel, aluminum, copper, brass, plastic, fiberglass and wood and the methods of joining them can vary considerably and may include, for example, use of adhesive material, casting them as a single form, etc.

The massage gun that the massage gun holder was originally designed to fit is called the HyperVolt® massage gun, available from Hyper Ice, Inc. This is one of the best-known massage gun in the sports recovery market and also the most widely knocked off. This device can fit any one of a variety of massage guns (e.g., ones that have a two-inch handle).

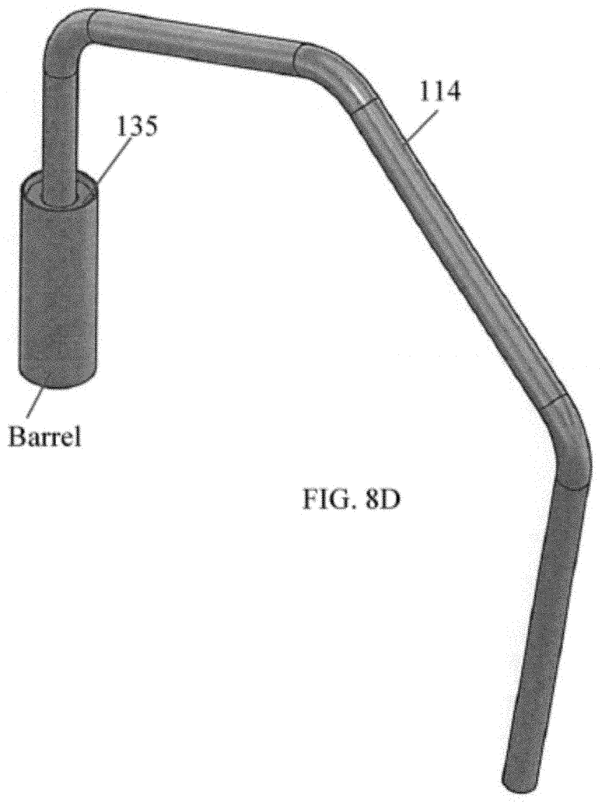

FIG. 8A is a schematic front view of an implementation of a shaft and barrel portion of a massage gun holder. FIG. 8A shows exemplary dimensions (in inches) and angles and variations thereof. As in all of the drawings, where a single dimension or angle is provided (with no corresponding range), it should be understood that the indicated dimension can be varied. In various implementations, the degree of variation may be, for example, +/−10% of more (e.g., +/−15%, +/−20%, +/−25%, etc.).

FIG. 8B is a schematic top view of an implementation of the shaft and barrel of the massage gun holder of FIG. 8A. FIG. 8B shows exemplary dimensions (in inches) and variations thereof. As in all of the drawings, where a single dimension or angle is provided (with no corresponding range), it should be understood that the indicated dimension can be varied. In various implementations, the degree of variation may be, for example, +/−10% of more (e.g., +/−15%, +/−20%, +/−25%, etc.).

FIG. 8C is a schematic side view of an implementation of the shaft and barrel of the massage gun holder of FIG. 8A. FIG. 8C shows exemplary dimensions (in inches) and variations thereof. As in all of the drawings, where a single dimension or angle is provided (with no corresponding range), it should be understood that the indicated dimension can be varied. In various implementations, the degree of variation may be, for example, +/−10% of more (e.g., +/−15%, +/−20%, +/−25%, etc.).

FIG. 8D is a schematic perspective view of an implementation of the shaft, barrel, and washer of the massage gun holder of FIG. 8A.

A number of embodiments of the invention have been described. Nevertheless, it will be understood that various modifications may be made without departing from the spirit and scope of the invention.

For example, the absolute and relative length of each section of tube can vary considerably. The number of bends and angle of each bend can vary considerably. The diameter (outer and inner) of the tube and/or barrel can vary. The size, shape, and number of windows in the barrel can vary. The outer and/or inner diameters of the barrel need not be larger than the outer and/or inner diameters of the tube; in some implementations, for example, they can be the same as the outer and/or inner diameters of the tube. Although the entirety of the tube shown in the drawings herein lies in a common plane, variations of that are possible. The latching mechanism can vary. For example, the latching mechanism could take the form of a hose clamp style connector that compresses (an optionally flexible) portion of the barrel onto the outer surface of the massage gun. The material that covers the tube to form the optional grip can vary. The materials of the various components can vary. The tube could be a solid material.

Other implementations are within the scope of the claims.

What is claimed is:

1. A massage gun holder comprising:
a tube having a first end and a second end;
a series of bends and straight segments in the tube between the first end and the second end; and
a massage gun engager at a second end of the tube to engage a portion of a massage gun.

2. The massage gun holder of claim 1, wherein the massage gun engager comprises:
a latching mechanism at a distal end of the massage gun engager to grip a portion of the massage gun that is engaged in the massage gun engager.

3. The massage gun holder of claim 1, wherein the bends in the series of bends add up to between 170 degrees and 210 degrees.

4. The massage gun holder of claim 3, wherein the series of bends in the tube comprises a first bend of 60 degrees (+/−10%), a second bend of 60 degrees (+/−10%), and a third bend of 70 degrees (+/−10%).

5. The massage gun holder of claim 4, wherein the first bend is 60 degrees, the second bend is 60 degrees, and the third bend is 70 degrees.

6. The massage gun holder of claim 1, wherein all of the bends in the tube are made in such a manner that every straight segment of the tube lies in a common plane with every other straight segment of the tube, with no portion of any of the segments extending out of the common plane.

7. The massage gun holder of claim 1, wherein all of the bends in the tube are made in the same direction.

8. The massage gun holder of claim 1, wherein the tube has an end-to-end length between 42 inches and 54 inches.

9. The massage gun holder of claim 8, wherein the tube comprises a first straight segment that is 14 inches (+/−10%), a second straight segment that is 14 inches (+/−10%), a third straight segment that is 13 inches (+/−10%), and a fourth straight segment that is 7 inches (+/−10%).

10. The massage gun holder of claim 9, wherein the tube comprises a first straight segment that is 14 inches, a second straight segment that is 14 inches, a third straight segment that is 13 inches, and a fourth straight segment that is 7 inches.

11. The massage gun holder of claim 9, wherein the first straight segment of the tube is separated from the second straight segment of the tube by a first bend, the second straight segment of the tube is separated from the third straight segment of the tube by a second bend, and wherein the third straight segment of the tube is separated from the fourth straight segment of the tube by a third bend.

12. The massage gun holder of claim 1, wherein the massage gun engager comprises:
a barrel portion coupled to the tube;
a collar portion coupled to a distal end of the barrel portion; and
a latching mechanism coupled to a distal end of the collar portion.

13. The massage gun holder of claim 12, wherein the barrel portion of the massage gun engager defines a window in a side surface thereof, wherein the window is sized and configured to enable a user to view and access, by hand, one or more controls or functional features on a bottom surface of a handle portion of a massage gun in the massage gun engager.

14. The massage gun holder of claim 12, further comprising:
a grip over an end of the tube opposite the barrel portion and configured to provides the user with a comfortable gripping surface.

15. A massage gun holder comprising:
a tube having a first end and a second end, wherein the tube has an end-to-end length between 42 inches and 54 inches;
a series of straight segments separated by bends between the first end and the second end of the tube, wherein the bends in the tube add up to between 170 degrees and 210 degrees;
a grip at the first end of the tube;
a massage gun engager at the second end of the tube, wherein the massage gun engager comprises:
a barrel portion coupled to the tube;
a collar portion coupled to a distal end of the barrel portion; and
a latching mechanism coupled to the collar portion,
wherein the barrel portion defines a window sized and configured to enable a user to view and access, by hand, one or more controls or functional features on a bottom surface of a handle portion of a massage gun in the massage gun engager,
wherein the tube comprises a first straight segment that is 14 inches long (+/−10%), a second straight segment that is 14 inches long (+/−10%), a third straight segment that is 13 inches long (+/−10%), and a fourth straight segment that is 7 inches long (+/−10%), and
wherein the first straight segment of the tube is separated from the second straight segment of the tube by a first bend of 60 degrees (+/−10%), wherein the second straight segment of the tube is separated from the third straight segment of the tube by a second bend of 60 degrees (+/−10%), and wherein the third straight segment of the tube is separated from the fourth straight segment of the tube by a third bend of 70 degrees (+/−10%), and
wherein all of the bends in the tube are made, such that the first, second, third, and fourth straight segments of the tube lie in a common plane, with no portion of the tube bending out of the common plane, and wherein all of the bends are in the same direction.

16. A massage system comprising:
a massage gun comprising:
a housing that defines a handle portion and a barrel portion, wherein the handle portion is angled relative to the barrel portion between 80° and 110°;
a vibrating member that extends out from a distal end of the barrel portion of the housing, wherein the vibrating member vibrates relative to the housing when the massage gun is operating; and
one or more controls or functional features on a bottom surface of the handle portion of the housing;
a massage gun holder comprising:
a tube having a first end and a second end;
a series of straight segments and bends between the first end and the second end;
a massage gun engager at the second end of the tube,
wherein the massage gun engager comprises:
a barrel portion coupled to the tube, wherein the barrel portion defines an opening at a distal end of the barrel portion and a window in a side surface of the barrel portion;
a collar portion coupled to a distal end of the barrel portion; and
a latching mechanism coupled to the collar portion,
wherein the massage gun is coupled to the massage gun holder, such that the handle portion of the massage gun is extended through the latching mechanism and the collar portion of the massage gun engager, and the latching mechanism is gripping the handle portion of the massage gun, and
wherein the window in the side surface of the barrel portion and the opening at the distal end of the barrel portion enable a user to view and access the one or more controls or functional features on the bottom surface of the handle portion of the housing of the massage gun.

17. The massage system of claim 16, wherein the tube comprises a first straight segment that is 14 inches long (+/−10%), a second straight segment that is 14 inches long (+/−10%), a third straight segment that is 13 inches long (+/−10%), and a fourth straight segment that is 7 inches long (+/−10%),
wherein the first straight segment of the tube is separated from the second straight segment of the tube by a first bend of 60 degrees (+/−10%), wherein the second straight segment of the tube is separated from the third straight segment of the tube by a second bend of 60 degrees (+/−10%), and wherein the third straight segment of the tube is separated from the fourth straight segment of the tube by a third bend of 70 degrees (+/−10%), and
wherein the first, second, third, and fourth straight segments of the tube lie in a common plane, with no portion of the tube bending out of the common plane,
wherein all of the bends are in the same direction,
wherein the tube has an end-to-end length between 42 inches and 54 inches, and
wherein the series of bends in the tube add up to between 170 degrees and 210 degrees.

18. The massage system of claim 16, wherein the massage gun holder further comprises:
a grip over an end of the tube opposite the massage gun engager, wherein the grip provides the user with a comfortable gripping surface.

19. A method of massaging a portion of one's own body, the method comprising:
obtaining a massage gun, the massage gun comprising:
a housing that defines a handle portion and a barrel portion, wherein the handle portion is angled relative to the barrel portion between 80° and 110°;
a vibrating member that extends out from a distal end of the barrel portion of the housing, wherein the vibrating member vibrates relative to the housing when the massage gun is operating; and
one or more controls or functional features on a bottom surface of the handle portion of the housing, wherein the one or more controls comprises a power button for the massage gun;
obtaining a massage gun holder, the massage gun holder comprising:
a tube having a first end and a second end;
a series of straight segments and bends between the first end and the second end of the tube, wherein the series of straight segments and bends includes, in order: a first straight segment, a first bend, a second straight segment, a second bend, a third straight segment, a third bend, and a fourth straight segment; and
a massage gun engager at the second end of the tube, wherein the massage gun engager comprises:
a barrel portion coupled to the tube, wherein the barrel portion defines an opening at a distal end of the barrel portion and a window in a side surface of the barrel portion;
a collar portion coupled to a distal end of the barrel portion; and
a latching mechanism coupled to the collar portion,
coupling the massage gun to the massage gun holder, such that the handle portion of the massage gun is extended through the latching mechanism and the collar portion of the massage gun engager and the latching mechanism is gripping the handle portion of the massage gun;
turning on the massage gun;
holding the massage gun holder with a first hand on or supporting the first straight segment of the tube and a second hand on or supporting the tube between the first bend 120 and the third bend, with the vibrating member of the massage gun in contact with a portion of the user's body to be massaged.

20. The method of claim 19, wherein the portion of the user's body to be massaged comprises the user's back, neck, shoulders, or the like.

21. The method of claim 19, wherein turning on the massage gun comprises:
manipulating the power button on the bottom surface of the handle portion of the massage gun through the window in the side surface of the barrel portion of the massage gun holder.
